(19) United States
(12) Patent Application Publication
(10) Pub. No.: US 2009/0000096 A1
(43) Pub. Date: Jan. 1, 2009

(54) RETAINING RING REMOVAL TOOL

(76) Inventor: Stephen Blok, Pembroke (CA)

Correspondence Address: NIKOLAI & MERSEREAU, P.A., 900 SECOND AVENUE SOUTH, SUITE 820, MINNEAPOLIS, MN, 55402, US

(21) Appl. No.: 12/147,635

(22) Filed: Jun. 27, 2008

(30) Foreign Application Priority Data
Jun. 28, 2007 (CA) 2593047

(51) Int. Cl. B25B 27/00

(52) U.S. Cl. 29/270

(57) ABSTRACT

A tool for removal of a rod from an opening in a ring clip or for insertion of the rod through the opening into the ring clip. The tool comprises a body having an upper surface, a ring clip receiving depression in that surface and an aperture in that surface extending below the depression and to one side thereof. The aperture is of a size to receive at least a portion of the rod to which is, or is to be, attached while the ring clip is seated within the depression. The depression has a base and walls which are configured so as to seat a ring clip therein to restrain it against relative movement in a direction towards the opening of the ring clip when the rod is moved in that direction for removal from the ring clip through the opening, and to restrain it against relative movement in an opposite direction when the rod is moved in that opposite direction to be inserted into the ring clip through the opening.

### FIELD OF THE INVENTION

The present invention relates to a tool to facilitate removal of pins, needles and rods from ring clips, such as e-clips.

### BACKGROUND OF THE INVENTION

Ring clips, such as e-clips, are very commonly used today. For instance e-clips are releasably positioned in one of a series of adjacent grooves in jet needles in internal combustion engine carburetors, to permit positioning of that needle to adjust fuel flow to the carburetor.

Because such clips are relatively small in size, and are under considerable tension when in position on the rod or pin, they are relatively difficult to remove or to insert in position on the rod or pin. Conventional tools, such as needle nose pliers, and screwdrivers, while they can be used, are not efficient or effective. Indeed, instructions for removing an e-clip from a needle often recommend that the safest way to remove the clip is to work in a clean uncluttered area so that if and when the clip flies into space, the mechanic has a better chance of finding the clip. Conventional instructions suggest laying the needle on a clean cloth or paper towel with the clip opening face down, putting fingers on the needle on either side of the clip, and pressing down gently so that the clip will pop off. The clip can be reinstalled in the same way or by using a pair of needle nose pliers to gently press the clip back in the selected groove. Care must be taken not to bend or scratch the needle.

It is an object of the present invention to provide a tool which will facilitate the insertion and removal of needles, pins, rods and like from ring clips. In the description and claims hereinafter, needles, pins and rods will be generically defined as simply “rods” and it should be understood that use of the word “rods” applies as well to needles, pins and similar structures.

### SUMMARY OF THE INVENTION

According to one aspect of the invention there is provided a tool for removal of a rod from an opening in a ring clip or for insertion of the rod through the opening into the ring clip. The tool comprises a body having an upper surface, a ring clip receiving depression in that surface and an aperture in that surface extending below the depression and to one side thereof. The aperture is of a size to receive at least a portion of the rod to which is, or is to be, attached while the ring clip is seated within the depression. The depression has a base and walls which are configured so as to seat a ring clip therein to restrain it against relative movement in a direction towards the opening of the ring clip when the rod is moved in that direction for removal from the ring clip through the opening, and to restrain it against relative movement in an opposite direction when the rod is moved in that opposite direction to be inserted into the ring clip through the opening.

In a specific embodiment of the invention, the body has opposed flat, parallel surfaces and a circumscribing edge, and a linear rod-receiving aperture which extends through the body, from surface to surface, from a central portion towards the peripheral edge, the walls of the depression circumscribing a central end of the aperture, which end extends centrally into the depression.

In a further embodiment of the present invention, the aperture of the tool extends from a side of the body inwardly to a central portion. A lever arm is pivotally attached to the body and arranged so as to exert sideways force on a portion of the rod, in the direction towards the opening of the ring clip. When the rod, with the ring clip attached thereto, is seated in the depression, it ejects the rod through the opening of the ring clip out into the adjacent portions of the aperture.

It will be immediately appreciated that a simple but effective tool is provided that will easily permit removal of rods from ring clips (or insertion of rods into ring clips) with a minimum of handling of the ring clip by tools or one's fingers.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the present patent specification as a whole.

### BRIEF DESCRIPTION OF THE DRAWINGS

These and other advantages of the invention will become apparent upon reading the following detailed description and upon referring to the drawings in which:

FIG. 1 is a perspective view of a ring clip removal and insertion tool according to one aspect of the present invention;

FIG. 2 is a central section view of the tool of FIG. 1 along line 2-2 as set out in FIG. 1;

FIG. 3 is a top plan view of the tool of FIG. 1;

FIG. 4 is a section view, similar to that of FIG. 2, with a rod and clip seated in the tool, ready for removal of the rod;

FIGS. 5 and 6 are perspective views, respectively, of the tool of FIGS. 1 to 4, with a ring clip seated, ready for rod removal in FIG. 5 and the rod removed (or ready for insertion into the ring clip), in FIG. 6;

FIG. 7 is a perspective view of an alternative embodiment of tool in accordance with the present invention, intended for larger rods; and

FIGS. 8A and 8B are side elevation sectional views of the tool of FIG. 7 illustrating respectively a rod and ring clip seated in the tool depression, ready for removal of the rod, and the rod in process of being removed from the ring clip.

The present invention will now be described by way of a non-limiting description of certain detailed embodiments.

### DETAILED DESCRIPTION OF THE PREFERRED EMBODIMENTS

In the following description, similar features in the drawings have been given identical reference numerals where appropriate. All dimensions described or suggested herein are intended solely to illustrate an embodiment. These dimensions are not intended to limit the scope of the invention that may depart from these dimensions.

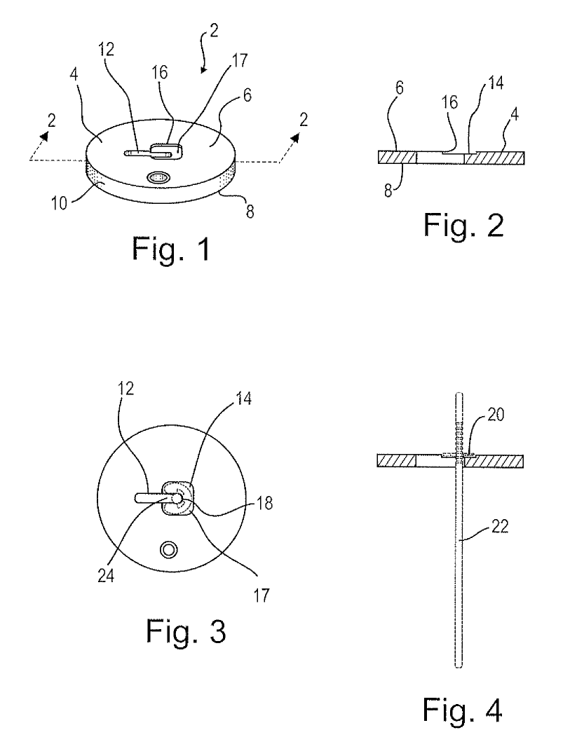

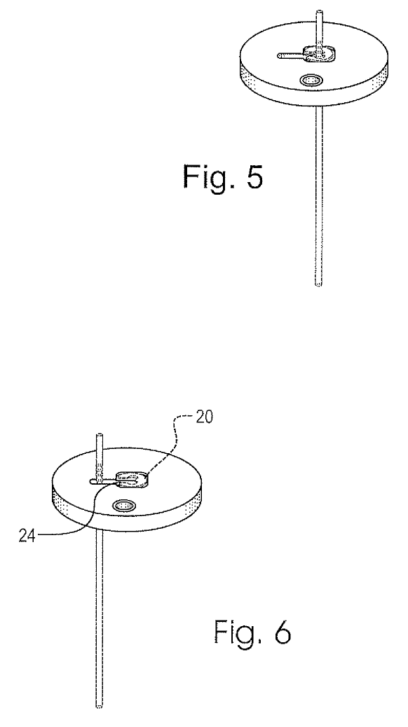

Turning to the embodiment of tool illustrated in FIGS. 1 to 6, there is illustrated a tool 2 for removal and insertion of rods with respect to ring clips comprising a body 4 having opposed flat parallel upper surface 6 and lower surface 8, and a circumscribing, circular peripheral edge 10. A linear, rod receiving aperture 12 extends through body 2, from surface to surface, the aperture disposed from a central portion of body 2, radially outwardly towards edge 10. A ring clip receiving depression 14 is provided in upper surface 6 as illustrated, the depression having walls 16 and a base 17 configured to seat a spring clip 20 in a manner which will be described in more detail subsequently. Depression 14 and its walls 16 circumscribe the central end 18 of slot 12. That central end 18 is centrally positioned within depression 14 as illustrated in FIG. 3.

As can be seen in FIGS. 4, 5 and 6, to remove a ring clip 20 from rod 22 (which is a needle in these drawings), ring clip 20 is seated in depression 14, with the opening 24 of ring clip 20 facing and aligned with aperture 12 (as in FIG. 3). In this manner, by simply forcing rod 22 to the left, portions of ring clip 20 on either side of opening 24 bear against walls 16 of depression 14, on each side of aperture 12, and rod 22 can be readily forced out of engagement within ring clip 20 (FIG. 6).

Ring clip 20 may be any type of resilient clip such as an “e-clip” or the like.

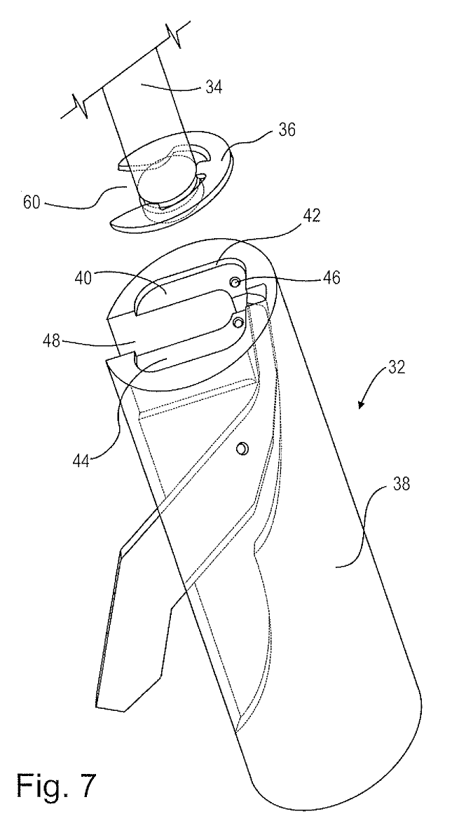

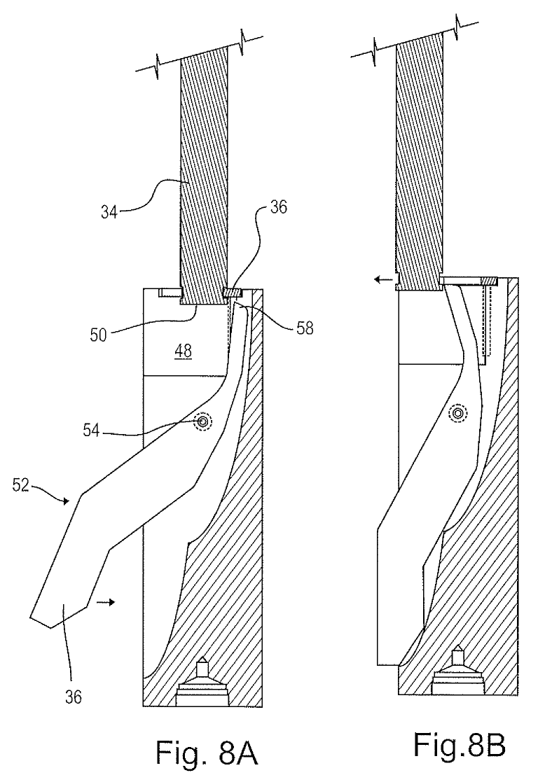

An alternative embodiment of tool 32, for removal and insertion of rods with respect to ring clips is illustrated in FIGS. 7, 8A and 8B. In this embodiment, intended for larger sizes of rods 34 and ring clips 36, a longer, cylindrical body 38 is provided as illustrated. At the top of body 38, a ring clip-holding depression 40, with wall 42 circumscribing a base 44 is provided. Magnets 46 may be embedded in base 44 to facilitate holding magnetically attractive ring clips 36 in place within depression 40. Instead of a linear slot 12 circumscribed by a body 4, as illustrated in the embodiment of FIGS. 1 to 6, an aperture 48, extends inwardly from the side of body 38 at the upper end thereof, aperture 48 being of a width to receive the upper end or head 50 of bolt 34 so that head 50, when ring clip 36 is seated in depression 40, extends into aperture 48 below that depression. The opening 60 of ring clip 36 is aligned with aperture 48, as suggested in FIG. 7.

Pivotally mounted within a slot extending below aperture 48 at the front of body 38 is a lever mechanism 52 which pivots relative to body 38 about pivot 54. Pushing lever handle 56 inwardly causes the head 58 of lever 52 to move towards and into the space of aperture 48, to bear against rod head 50 while ring clip 36 is prevented from movement, in the same direction, by the portions of ring clip 36, on either side of opening 60, bearing against front portions of wall 42 (FIGS. 8A and 8B). This action forces rod 34 out of ring clip 36, while ring clip 36 remains seated in depression 40.

To insert rod 34 into ring clip 36, ring clip 36 is seated in depression 40, with clip opening 60 aligned with the front of body 38 and aperture 46. In this manner rod 34 may be slid inwardly, with its head 50 passing through aperture 48, into engagement with ring clip 36. The back portion of wall 42 holds ring clip 36 in place while this operation takes place. Lever mechanism 52 is not required for this maneuver.

Although the present invention has been described by way of a detailed description in which various embodiments and aspects of the invention have been described, it will be seen by one skilled in the art that the full scope of this invention is not limited to the examples presented herein. The invention has a scope which is commensurate with the claims of this patent specification including any elements or aspects which would be seen to be equivalent to those set out in the accompanying claims.

1. A tool for removal of a rod from an opening in a ring clip or for insertion of the rod into the opening in the ring clip, the tool comprising:
(a) a body having an upper surface;
(b) a ring clip receiving depression in that surface;
(c) an aperture in that surface extending below the depression and to one side thereof, the aperture of a size to receive at least a portion of the rod to which the ring clip is, or is to be, attached while the ring clip is seated within the depression,
the depression having a base and walls configured so as to seat a ring clip therein to restrain it against relative movement in a direction towards the opening of the ring clip when the rod is moved in that direction for removal from the ring clip through the opening, and to restrain it against relative movement in an opposite direction when the rod is moved in that opposite direction to be inserted into the ring clip through the opening.

2. A tool according to claim 1, wherein the body has opposed flat, parallel surfaces and a circumscribing edge, and a linear rod-receiving aperture extends through the body, from surface to surface, from a central portion towards the peripheral edge, the walls of the depression circumscribing a central end of the aperture extending centrally into the depression.

3. A tool according to claim 2, wherein the body is of circular, disk-like appearance.

4. A tool according to claim 2, wherein the height of the wall is similar to that of a thickness of a ring clip to be seated in the depression.

5. A tool according to claim 1, wherein the aperture extends from a side of the body inwardly to a central portion, and a lever arm is pivotally attached to the body and arranged so as to exert sideways force on a portion of the rod, in the direction towards the opening of the ring clip, when the rod, with the ring clip attached thereto, is seated in the depression, to eject the rod through the opening of the ring clip out into the adjacent portions of the aperture.

6. A tool according to claim 5, wherein the depression is provided with magnetic means to retain magnetically attractive ring clips therein during use of the tool.
